(19) United States
(12) Patent Application Publication
(10) Pub. No.: US 2008/0303927 A1
(43) Pub. Date: Dec. 11, 2008

(54) DIGITAL MOTION PICTURE CAMERA WITH TWO IMAGE SENSORS

(75) Inventor: Tran Quoc Khanh, Darmstadt (DE)

Correspondence Address: GIFFORD, KRASS, SPRINKLE,ANDERSON & CITKOWSKI, P.C, PO BOX 7021, TROY, MI, 48007-7021, US

(73) Assignee: Arnold & Richter Cine Technik GmbH & Co. Betriebs KG, Munich (DE)

(21) Appl. No.: 12/132,658

(22) Filed: Jun. 4, 2008

(30) Foreign Application Priority Data
Jun. 6, 2007 (DE) 10 2007 026 337.8

(51) Int. Cl. H04N 5/225

(52) U.S. Cl. 348/262; 348/E05.024

(57) ABSTRACT

The invention relates to a digital camera, in particular to a digital motion picture camera, for the taking of images, having a first sensor, a second sensor and a beam splitter to direct received light onto the first sensor and onto the second sensor, said sensors each including a plurality of sensor elements for the generation of exposure-dependent received signal values, with the sensor elements of the first sensor being associated with the sensor elements of the second sensor such that the mutually associated sensor elements detect the same image regions. An evaluation and control device compares the received signal value of at least some of the sensor elements of the first sensor or of the second sensor with a respective threshold value. The evaluation and control device selects either the received signal value of the sensor element of the first sensor or the received signal value of the associated sensor element or of the plurality of associated sensor elements of the second sensor for the generation of a respective output value in dependence on the result of the respective comparison.

The present invention relates to a digital camera, in particular to a digital motion picture camera, for the taking of images. The invention further relates to a corresponding method.

A sensor element of a sensor of a digital camera, for example a CCD sensor element or a CMOS sensor element, generates charges which represent a measure for the quantity of light incident onto the respective sensor element, i.e. the respective exposure. However, there are limits in this respect due to noise and saturation. Particularly low quantities of light and particularly high quantities of light can no longer be distinguished so that the dynamic range of the sensor of a digital camera is limited. Real contrast ranges of a motif or of a scene can thus not always be detected with the desired differentiation—i.e. brightness resolution—by the digital camera.

To increase the dynamic range of a digital camera, it is known to take a plurality of individual images sequentially, which are taken with different exposure times, for each image and subsequently to combine the individual images, for example by superimposition of selected image sections from the different individual images of the exposure series. Since, however, the plurality of individual images are taken sequentially and the sensor of the digital camera has to be read out in between times, spatial aliasing effects can occur with moving motifs.

It is the underlying object of the invention to provide a possibility which allows images of motifs or scenes to be taken with a higher brightness resolution.

This object is satisfied by a digital camera having the features of claim 1 and in particular by a digital camera having a first sensor, a second sensor and a beam splitter to direct received light onto the first sensor and onto the second sensor, said sensors each including a plurality of sensor elements for the generation of exposure-dependent received signal values, with the sensor elements of the first sensor being associated with the sensors elements of the second sensor such that the mutually associated sensor elements detect the same image regions, with the sensors and the beam splitter being configured such that, when the same image is taken, the mutually associated sensor elements generate different received signal values, and with an evaluation and control device being provided by which the received signal values of at least some of the sensor elements of the first sensor or of the second sensor can be compared with a respective threshold value, with the evaluation and control device selecting either the received signal value of the sensor element of the first sensor or the received signal value of the associated sensor element or of a plurality of associated sensor elements of the second sensor for the generation of a respective output value in dependence on the result of the respective comparison.

This object is satisfied for a method having the features of claim 20 and in particular by a method for the taking of images by means of a digital camera having a first sensor and a second sensor, said sensors each including a plurality of sensor elements, wherein received light is directed onto the first sensor and onto the second sensor by means of a beam splitter, with the sensor elements of the first sensor being associated with the sensor elements of the second sensor such that the mutually associated sensor elements detect the same image regions, wherein furthermore exposure-dependent received signal value are generated by the sensor elements, with the sensors and the beam splitter being configured such that, when the same image is taken, the mutually associated sensor elements generate different received signal values, wherein furthermore the received signal values of at least some of the sensor elements of the first sensor or of the second sensor are compared with a respective threshold value, and wherein either the received signal value of the sensor element of the first sensor or the received signal value of the associated sensor element or of a plurality of associated sensor elements of the second sensor is selected for the generation of a respective output value in dependence on the result of the respective comparison.

Two sensors are therefore used. Light received by the camera is split by a beam splitter, for example a semi-permeable mirror or a rotating mirror diaphragm, and is directed onto the first sensor and onto the second sensor. Consequently, the two sensors each take the same image simultaneously or at least at a short interval after one another. The sensors each include a plurality of sensor elements, for example CCD sensor elements or CMOS sensor elements which generate received signal values in dependence on the respective incident quantity of light. The received signal values are preferably digital values which are generated by A/D conversion of analog received signal values of the sensor elements, for example of charge values, with such a digital value also being called a “code value”. The sensor elements preferably each have an at least substantially linear exposure/received signal value characteristic. To the extent that the analog received signal values of the sensor elements do not vary in a linear fashion with the exposure, this can be compensated in the digitization based on corresponding calibration.

In this connection, the camera is configured such that that or those respective sensor elements of the second sensor which detects or detect the same region of the taken image are associated with the sensor elements of the first sensor. The respective mutually associated sensor elements differ, however, in that they generate received signal values of different levels. Sensor elements which deliver lower received signal values in particular move less fast into saturation than sensor elements which deliver higher received signal values so that the sensor whose sensor elements deliver lower received signal values can be exposed for longer before the saturation limit is reached.

An evaluation and control device is furthermore provided. The evaluation and control device is provided to decide on the basis of a comparison of a received signal value of a sensor element of the first sensor or of the second sensor with a threshold value whether an output value for the respective image region is generated either on the basis of the received signal value of the first sensor or on the basis of the received signal value of the associated sensor element or of a plurality of associated sensor elements of the second sensor. It is hereby made possible to use the received signal values of the sensor with the lower received signal values in bright image regions and to use the received signal values of the sensor with the higher received value in dark image regions for the generation of a digital output image which can be composed of the output values of all the image regions and is output, for example, to a signal output of the evaluation and control device. The received signal value of the plurality of associated sensor elements of the second sensor can, for example, be the received signal value of an individual one of the plurality of sensor elements or a received signal value which is calculated, in particular averaged, from the plurality of sensor elements or from some of them.

The dynamic range can thus be increased by the digital camera in accordance with the invention or by the method in accordance with the invention with respect to known digital cameras which do not have any second sensor. Since the same image is taken simultaneously or at least substantially simultaneously by the two sensors, moving motifs or scenes can also be taken.

The generation of the different received signal values can be achieved, for example, in that the sensitivity of the sensor elements of the second sensor is less than the sensitivity of the sensor elements of the first sensor.

In particular for this purpose, the second sensor can have a higher spatial resolution than the first sensor, i.e. the second sensor can have a higher number of sensor elements per unit of area, with a plurality of sensor elements of the second sensor being associated with each sensor element of the first sensor.

Alternatively or additionally, the generation of different received signal values can also be achieved, for example, in that the beam splitter directs a lower amount of light in the direction of the second sensor than in the direction of the first sensor. The received light is in this connection not split equally between the two sensors, but rather in a disparate ratio, for example of 80:20, with less light preferably being directed onto the second sensor.

In accordance with an embodiment of the invention, the first sensor is made as a color sensor whose sensor elements are divided into a plurality of groups, with the sensor elements of the different groups having different spectral sensitivities. It is made possible to take color images by a color sensor. The color sensor can be provided with a color filter arrangement, in particular with a so-called Bayer color filter arrangement which is disclosed, for example, in the patent U.S. Pat. No. 3,971,065, whose content is herewith included in this application.

The second sensor can be made as a monochrome sensor whose sensor elements all have the same spectral sensitivity. The monochrome sensor which preferably only has luminance-sensitive sensor elements can, for example, be a sensor only sensitive in the green spectral range or a sensor without color filtering. Luminance-sensitive sensor elements are disclosed, for example, in the patent U.S. Pat. No. 3,971,065 already mentioned above.

In accordance with a further embodiment of the invention, the output values selected by the evaluation and control device only represent information from luminance-sensitive sensor elements. With a digital camera having a color sensor and a monochrome sensor, this can in particular be achieved in that only received signal values from luminance-sensitive sensor elements of the color sensor, for example sensor elements only sensitive in the green spectral range, are compared with the threshold value.

The evaluation and control device is preferably configured to generate the respective output value on the basis of the received signal value of the sensor element of the first sensor with a received signal value of a sensor element of the first sensor or of the second sensor which is smaller than the threshold value. For example, the received signal value of the first sensor can be multiplied by a scaling factor, which is in particular constant, of greater than 0 and less than 1 for the generation of the respective output value. It is, however, particularly preferred for the respective output value to correspond to the received signal value of the sensor element of the first sensor. It is hereby achieved that the received signal values of the first sensor can simply be taken over up to a specific luminous intensity.

The evaluation and control device is preferably configured to generate the respective output value on the basis of the received signal value of the sensor element or of the plurality of sensor elements of the second sensor with a received signal value of a sensor element of the first sensor or of the second sensor which exceeds the threshold value. The received signal value of the second sensor can, for example, simply be taken over for the generation of the respective output value. It is, however, particularly preferred if, on a comparison of a received signal value of a sensor element of the first sensor with a threshold value, the generation of the respective output value takes place on the basis of the equation A=S_{E}+a×(E_{Z}−S_{Z}), where A is the output value, S_{E} is the threshold value, a is a constant greater than 0 and less than 1, E_{Z} is the received signal value of the sensor element or of the plurality of sensor elements of the second sensor and S_{Z} is that received signal value of the sensor element or of the plurality of sensor elements of the second sensor at which the received signal value of the associated sensor element of the first sensor corresponds to the threshold value. Alternatively or additionally, on a comparison of a received signal value of a sensor element or of a plurality of sensor elements of the second sensor with a threshold value, the generation of the respective output value can take place in accordance with the equation A=S_{E}+a×(E_{Z}−S_{Z}), where A is the output value, S_{Z} is the threshold value, a is a constant greater than 0 and less than 1, E_{Z} is the received signal value of the sensor element or of the plurality of sensor elements of the second sensor and S_{E} is that received signal value of the sensor element of the first sensor at which the received signal value of the associated sensor element or of the plurality of sensor elements of the second sensor corresponds to the threshold value.

The difference of two respective generated output values can in particular be less than the difference of the received signal values underlying the two output values.

With a color sensor in which the sensor elements can each only detect one color value, for example either green blue or red, the other color values, in particular the other two color values, are generated by interpolation from adjacent sensor elements. Algorithms for such a color interpolation are generally known. In this respect, it can, for example, be a case of non-adaptive interpolation methods such as “nearest neighbor” interpolation or methods of bilinear interpolation by which blurred edges can, however, arise in the images. It is therefore preferred for the first sensor to be made as a color sensor whose sensor elements are divided into a plurality of groups, with the sensor elements of the different groups having different spectral sensitivities, with the second sensor being made as a monochrome sensor whose sensor elements all have the same spectral sensitivity, and with the second sensor having a higher spatial resolution than the first sensor. The evaluation and control device in this case identifies edge structures in the respective image on the basis of the received signal values of the monochrome sensor with higher resolution with reference to a usual pattern recognition algorithm. The evaluation and control device selects the respective interpolation environment in dependence on the identified edge structures for the color interpolation of the received signal value of the color sensor with the lower resolution. If therefore an edge is identified in a predetermined environment of a picture element for which a color interpolation should be carried out, received signal values of picture elements which are disposed outside this identified edge are not taken into account in the color interpolation.

Already known adaptive interpolation methods such as the gradient method can be used to take account of the interpolation environment. However, more defined edges can be generated by the using of the received signal distribution, in particular the brightness distribution of the monochrome sensor as the base, than on using a luminance mask which is determined from the luminance-sensitive sensor elements of the color sensor since the luminance-sensitive sensor elements of the color sensor only represent some of all the sensor elements of the color sensor and the color sensor additionally has a lower resolution than the monochrome sensor.

In accordance with a further embodiment of the invention, the first sensor and the second sensor have the same image taking frequency.

An anti-aliasing filter is preferably only connected in front of the first sensor of the two sensors, with the second sensor having a higher spatial resolution than the first sensor. The anti-aliasing filter which is known per se and which effects a low pass filtering is used to counter a color alias. Structural information of an image filtered by the anti-aliasing filter can, however, be regained again by means of the second sensor in the cases in which the second sensor of higher resolution can still resolve the filtered structural information so that the low pass filtering carried out with respect to the first sensor does not have a negative effect on the spatial resolution of the digital camera.

In accordance with an advantageous embodiment, the camera has an electronic viewfinder, for example a liquid crystal display. This electronic viewfinder is only connected to one of the two sensors to reproduce its received signal values. The image frame shown at the electronic viewfinder can thus be reproduced without any substantial delay with respect to the generation of the received signal values of the respective sensor.

In this context, it is particularly advantageous for the camera to have a switching device by means of which selectively either the first sensor or the second sensor can be connected to the electronic viewfinder. The cameraman can thus select between a particularly sharply represented monochrome reproduction of the image frame or a color reproduction of the image frame with a better representation of the esthetic overall impression.

Non-restricting embodiments of the invention are shown in the drawing and will be described in the following.

There are shown in a schematic representation in each case:

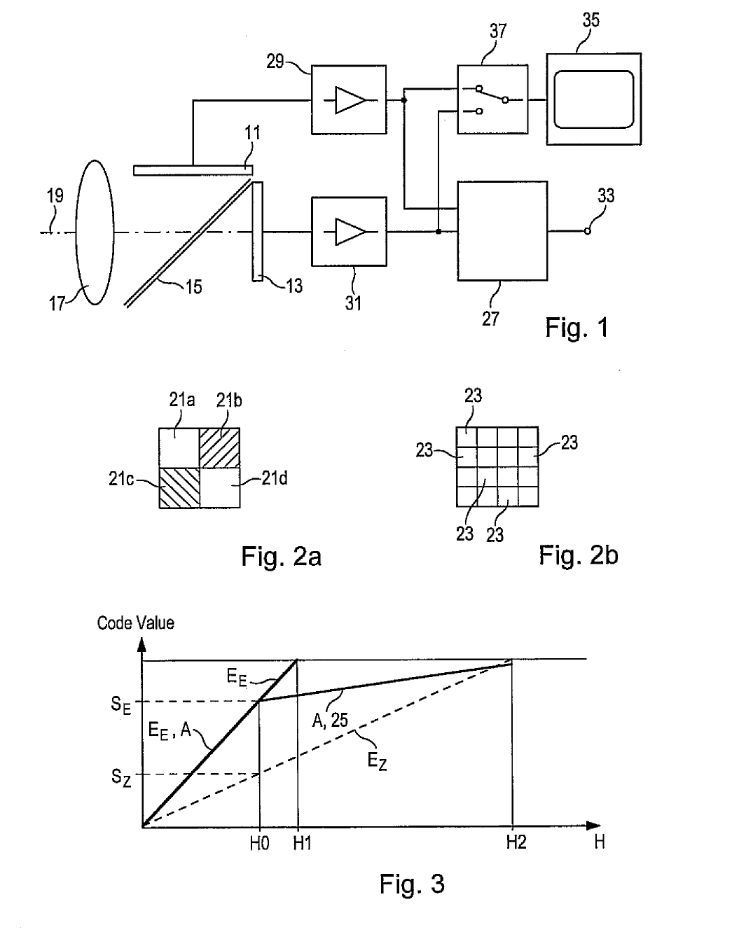

FIG. 1 a digital camera in accordance with the invention with a first sensor and a second sensor;

FIGS. 2a, 2b a section of the first sensor and second sensor respectively from FIG. 1; and

FIG. 3 a diagram for the illustration of received signal values of the sensor elements of the sensors and of output values, in each case in dependence on the exposure.

The digital camera shown in FIG. 1 includes a beam splitter 15 which is arranged after an optical receiving system 17 and which is inclined at 45° with respect to the optical axis 19 of the camera and directs light incident along the optical axis 19 of the camera by means of reflection partly onto a first sensor 11 and by means of transmission partly onto a second sensor 13. The beam splitter 15 preferably has a thickness of a maximum of 35 μm, in particular of 25 μm. The beam splitter 15 can in particular be provided with an optical interference layer to vary the ratio of reflection to transmission. The two sensors 11 and 13 are each composed of a plurality of sensor elements.

The first sensor 11 is made as a color sensor which has a color filter arrangement in accordance with the Bayer pattern. The section of the color sensor 11 shown in FIG. 2a, said section repeating in both the vertical and in the horizontal directions over the total color sensor 11, shows four sensor elements 21a, 21b, 21c, 21d which are of equal size, which are arranged in a square and of which the two sensor elements 21a and 21d are each only sensitive in the green spectral range, the sensor element 21b is only sensitive in the blue spectral range and the sensor element 21c is only sensitive in the red spectral range. The sensor elements 21a, 21b, 21c, 21d made in a square preferably each have an edge length of 6 μm to 10 μm, in particular of 8 μm. With a picture format of, for example, 24 mm×18 mm, 3 k sensor elements (8 μm×3 k=24 mm) are thus arranged next to one another.

For reasons of simplicity, in the following, sensor elements only sensitive in the green spectral range are called “green” sensor elements, sensor elements only sensitive in the blue spectral range are called “blue” sensor elements, and sensor elements only sensitive in the red spectral range are called “red” sensor elements. Green sensor elements can also be called luminance-sensitive sensor elements.

The second sensor 13 is made as a monochrome sensor which only has green sensor elements 23, as can be recognized from FIG. 2b. The monochrome sensor 13 can be provided either with a corresponding glass filter or with color lacquer for this purpose. The section of the monochrome sensor 13 shown in FIG. 2b, which repeats in both the vertical direction and in the horizontal direction over the total monochrome sensor 13, shows a total of 16 green sensor elements 23 which are of equal size, which are arranged in a square and which each preferably have an edge length of 3 μm to 5 μm, in particular of 4 μm. With a picture format of, for example, 24 mm×18 mm, 6 k sensor elements (4 μm×6 k=24 mm) are thus arranged next to one another. Four sensor elements 23 each of the monochrome sensor 13 are each associated with a respective one of the sensor elements 21a, 21b, 21c, 21d of the color sensor 11 in that they detect the same image region of the image frame imaged by the optical receiving system 17.

The monochrome sensor 13 consequently has a higher spatial resolution than the color sensor 11, i.e. the sensor element density of the monochrome sensor 13 is larger than that of the color sensor 11. The light-sensitive surfaces of the sensor elements 21 of the color sensor 11 are larger than those of the sensor elements 23 of the monochrome sensor 13. With sensor elements 21, 23 otherwise made the same, this has the result that the sensitivity of a sensor element 23 of the monochrome sensor 13 is less than the sensitivity of a sensor element 21 of the color sensor 11.

This has the result that, with the same exposure H, a received signal value E_{E} generated by a green sensor element 21a, 21d of the color sensor 11 is greater than a received signal value E_{Z} generated by one of the associated green sensor elements 23 of the monochrome sensor 13 or a received signal value E_{Z} calculated, in particular averaged, from the plurality of associated sensor elements 23 of the monochrome sensor 13 or from some of them.

This is shown in FIG. 3. The green sensor element 23 of the monochrome sensor 13 consequently only moves into saturation on a limit exposure H2, whereas the associated green sensor element 21a, 21d of the color sensor 11 already moves into saturation on a lower limit exposure H1. In FIG. 3, the received signal values E_{E} and E_{Z} are each present as digital values and can adopt a value from 0 up to a maximum “code value, for example 2¹⁶. Both the green sensor element 23 of the monochrome sensor 13 and the associated green sensor element 21a, 21d of the color sensor 11 each have a linear exposure/received signal characteristic, with the gradient of the characteristic of the green sensor element 23 of the monochrome sensor 13 being smaller than the gradient of the characteristic of the green sensor element 21a, 21d of the color sensor 11. The difference in the gradients of the linear characteristics of the two sensors 11, 13 can be varied by varying the ratio of reflection to transmission at the beam splitter 15.

The digital camera furthermore includes an evaluation and control device 27 (e.g. a microcontroller). The evaluation and control device 27 is coupled to the first sensor 11 via a signal processing device 29 and to the second sensor 13 via a signal processing device 31. The signal processing devices 29, 31 include, for example, amplifiers, multiplexers and analog/digital converters for the amplification, reading out and digitizing of the received signal values E_{E}, E_{Z}. The evaluation and control device 27 is configured to compare the received signal values E_{E} of the green sensor elements 21a, 21d of the color sensor 11 in each case with a threshold value S_{E} which is preferably of equal size for all the green sensor elements 21a, 21d of the color sensor 11, The threshold value S_{E} can, for example, be 60% of the maximum “code value” which corresponds to a threshold value exposure H0 at which the monochrome sensor 13 generates a received signal value E_{Z} of E_{Z}=S_{Z}.

If the received signal value E_{E} of the respective green sensor element 21a, 21d of the color sensor 11 is below the threshold value S_{E}, the received signal value E_{E} of the respective green sensor element 21a, 21 of the color sensor 11 is used as the output value A for the respective image region at a signal output 33 of the evaluation and control device 27.

If the received signal value E_{E} of the respective green sensor element 21a, 21d of the color sensor 11 is, however, above the threshold value S_{E}, the output value A for the image region which is detected by the respective green sensor element 21a, 21d of the color sensor 11 is calculated according to the following equation:

A=S_{E}+a×(E_{Z}−S_{Z}),

where A corresponds to the output value, S_{E} to the threshold value, a to a constant >0 and <1, E_{Z} to the received signal value of the sensor element 23 or to the plurality of sensor elements 23 of the monochrome sensor 13 and S_{Z} to that received signal value of the sensor element 23 or of the plurality of sensor elements 23 of the monochrome sensor 13 at which the received signal value E_{E} of the associated sensor element 21a, 21d of the color sensor 11 corresponds to the threshold value S_{E}. Consequently, the respective green sensor element 21a, 21d of the color sensor 11 is allocated an output value A which is generated on the basis of the received signal value E_{Z} of one of the plurality of associated sensor elements 23 of the monochrome sensor 13 or of the plurality of associated sensor elements 23 of the monochrome sensor 13 or of some of them.

Up to the threshold exposure H0, the output value A for the respective image region consequently corresponds to the received signal value E_{E} of the respective green sensor element 21a, 21d of the color sensor 11, with the output value A increasing in a linear fashion with the exposure H. From the threshold exposure H0, the output value A follows the straight line marked by 25 in FIG. 3 which has a lower gradient than the exposure/received signal value characteristics of the green sensor elements 21a, 21d, 23 of the color sensor 11 and of the monochrome sensor 13.

The dynamic range of the digital camera can hereby be increased since exposures H can be taken in a distinguishable manner not only up to the limit exposure H1 of the green sensor elements 21a, 21d of the color sensor 11, but also beyond this, namely up to the higher limit exposure H2 of the green sensor elements 23 of the monochrome sensor 13.

In addition to the output values A for the green sensor elements 21a, 21d of the color sensor 11 generated as above, output values are furthermore generated for the blue and red sensor elements 21b, 21c of the color sensor 11 and are output at the output 33. The respective digital color image can then be compiled in a known manner from the output values A for all the green, blue and red sensor elements 21a, 21b, 21c, 21d, with the brightness distribution resulting from the received signal values E_{Z} of the monochrome sensor 13 being used as the basis for the color interpolation known per se for the taking into account of edge structures.

The equations explained above for the calculation of the output values A are to be understood as examples and can be modified by scaling, for example.

Alternatively, with an otherwise analog procedure to the above—instead of comparing the received signal value E_{E} of the respective green sensor element 21a, 21d of the color sensor 11 with the threshold value S_{E}—the received signal value E_{Z} of one of the associated green sensor elements 23 of the monochrome sensor 13 or of the plurality of associated sensor elements 23 of the monochrome sensor 13 or of some of them can also be compared with the value S_{Z}.

Generally, the method explained above can also be applied when the monochrome sensor 13 does not have any higher spatial resolution, but receives less light than the color sensor 11. It is besides also conceivable that two monochrome sensors or two color sensors are used, with the one sensor having a higher spatial resolution than the other.

Finally, another advantageous further development of the invention can be seen from FIG. 1. The camera has an electronic viewfinder 35 which is selectively connected via a switching device 37 either only to the first sensor 11 or only to the second sensor 13. The cameraman can thus choose between a color reproduction of the image frame with a representation of the esthetic total impression (sensor 11) or a monochrome reproduction of the image frame (sensor 13) shown with a particular definition by a corresponding actuation of the switching device 37. The coupling of the electronic viewfinder (35) either with the first sensor (11) or with the second sensor (13) can be selected independently of whether the respective output value A is generated by means of the evaluation and control device 27 on the basis of the received signal values E_{E} of the sensor elements 21a, 2 1d of the first sensor 11 or on the basis of the received signal values E_{Z} of the sensor elements 23 of the second sensor 13.

### REFERENCE NUMERAL LIST

11 color sensor
13 monochrome sensor
15 beam splitter
17 optical receiving system
19 optical axis
21 sensor element of the color sensor
23 sensor element of the monochrome sensor
25 output values above the threshold value exposure
27 evaluation and control device
29 signal processing device
31 signal processing device
33 signal output
35 electronic viewfinder
37 switching device
A output value
E_{E} received signal value
E_{Z} received signal value
H exposure
H0 threshold value exposure
H1 limit exposure
H2 limit exposure
S_{E} threshold value
S_{Z} threshold value

1. A digital camera, in particular a digital motion picture camera, for the talking of images, having a first sensor (11), a second sensor (13) and a beam splitter (15) to direct received light onto the first sensor (11) and onto the second sensor (13), said sensors (11, 13) each including a plurality of sensor elements (21, 23) for the generation of exposure-dependent received signal values (E_{E}, E_{Z}),
wherein the sensor elements (21) of the first sensor (11) are associated with the sensor elements (23) of the second sensor (13) such that the mutually associated sensor elements (21, 23) detect the same image regions;
wherein the sensors (11, 13) and the beam splitter (15) are configured such that, when the same image is taken, the mutually associated sensor elements (21, 23) generate different received signal values (E_{E}, E_{Z}); and
wherein an evaluation and control device (27) is provided by which the received signal values (E_{Z}, E_{Z}) from at least some (21a, 21d) of the sensor elements (21) of the first sensor (11) or of the second sensor (13) are comparable with a respective threshold value (S_{E}, S_{Z}), with the evaluation and control device (27) being configured to select either the received signal value (E_{E}) of the sensor element (21a, 21d) of the first sensor (11) or the received signal value (E_{Z}) of the associated sensor element (23) or of a plurality of associated sensor elements (23) of the second sensor (13) for the generation of a respective output value (A) in dependence on the result of the respective comparison.

2. A digital camera in accordance with claim 1, characterized in that the sensitivity of the sensor elements (23) of the second sensor (13) is less than the sensitivity of the sensor elements (21) of the first sensor (11).

3. A digital camera in accordance with claim 1, characterized in that the second sensor has a higher spatial resolution than the first sensor (11).

4. A digital camera in accordance with claim 1, characterized in that the beam splitter (15) directs a lower quantity of light in the direction of the second sensor (13) than in the direction of the first sensor (11).

5. A digital camera in accordance with claim 1, characterized in that the first sensor (11) is made as a color sensor whose sensor elements (21) are divided into a plurality of groups, with the sensor elements (21) of the different groups having different spectral sensitivities.

6. A digital camera in accordance with claim 1, characterized in that the second sensor (13) is made as a monochrome sensor whose sensor elements (23) all have the same spectral sensitivity.

7. A digital camera in accordance with claim 1, characterized in that the output values (A) selected by the evaluation and control device (27) only represent information from luminance-sensitive sensor elements (21a, 21d, 23).

8. A digital camera in accordance with claim 1, characterized in that the evaluation and control device (27) is made to generate the respective output value (A) on the basis of the received signal value (E_{E}) of the sensor element (21a, 21d) of the first sensor (11) when a received signal value (E_{E}, E_{Z}) of a sensor element (21a, 21d) of the first sensor (11) or of the second sensor (13) is smaller than the threshold value (S_{E}, S_{Z}).

9. A digital camera in accordance with claim 8, characterized in that the respective output value (A) corresponds to the received signal value (E_{E}) of the sensor element (21a, 21d) of the first sensor (11).

10. A digital camera in accordance with claim 1, characterized in that the evaluation and control device (27) is made to generate the respective output value (A) on the basis of the received signal value (E_{Z}) of the sensor element (23) or of the plurality of sensor elements (23) of the second sensor (13) when a received signal value (E_{E}, E_{Z}) of a sensor element (21a, 21d) of the first sensor (11) or of the second sensor (13) exceeds the threshold value (S_{E}, S_{Z}).

11. A digital camera in accordance with claim 10, characterized in that, as a result of the comparison of a received signal value (E_{E}) of a sensor element (21a, 21d) of the first sensor (11) with the respective threshold value (S_{E}), the generation of the respective output value takes place on the basis of the equation A=S_{E}+a×(E_{Z}−S_{Z}), where A corresponds to the output value, S_{E} to the threshold value, a to a constant greater than 0 and less than 1, E_{Z} to the received signal value of the sensor element (23) or of the plurality of sensor elements (23) of the second sensor (13), and S_{Z} to that received signal value of the sensor element (23) or of the plurality of sensor elements (23) of the second sensor (13) at which the received signal value (E_{E}) of the associated sensor element (21a, 21d) of the first sensor (11) corresponds to the threshold value (S_{E}).

12. A digital camera in accordance with claim 10, characterized in that, as a result of the comparison of a received signal value (E_{Z}) of a sensor element (23) or of a plurality of sensor elements (23) of the second sensor (13) with the respective threshold value (S_{Z}), the generation of the respective output value takes place on the basis of the equation A=S_{E}+a×(E_{Z}−S_{Z}), where A corresponds to the output value, S_{Z} to the threshold value, a to a constant greater than 0 and less than 1, E_{Z} to the received signal value of the sensor element (23) or of the plurality of sensor elements (23) of the second sensor (13), and S_{E} to that received signal value of the sensor element (21a, 21d) of the first sensor (11) at which the received signal value (E_{Z}) of the associated sensor element (23) or of the plurality of sensor elements (23) of the second sensor (13) corresponds to the threshold value (S_{Z}).

13. A digital camera in accordance with claim 10, characterized in that the difference of two respective generated output values (A) is less than the difference of the received signal values (E_{Z}) underlying the two output values (A).

14. A digital camera in accordance with claim 1, characterized in that the first sensor (11) is made as a color sensor whose sensor elements (21) are divided into a plurality of groups, with the sensor elements (21) of the different groups having different spectral sensitivities;
in that the second sensor (13) is made as a monochrome sensor whose sensor elements (23) all have the same spectral sensitivity, with the second sensor (13) having a higher spatial resolution than the first sensor (11); and
in that the evaluation and control device (27) is made to identify edge structures in the respective image on the basis of the received signal values (E_{Z}) of the second sensor (13) with the higher resolution and, for a color interpolation of the received signal values (E_{E}) of the first sensor (11) with the lower resolution, to select the respective interpolation environment in dependence on the identified edge structures.

15. A digital camera in accordance with claim 1, characterized in that the first sensor (11) and the second sensor (13) have the same image taking frequency.

16. A digital camera in accordance with claim 1, characterized in that an anti-aliasing filter is only connected in front of the first sensor (11) of the two sensors (11, 13), with the second sensor (13) having a higher spatial resolution than the first sensor (11).

17. A digital camera in accordance with claim 1, characterized in that the camera has an electronic viewfinder (35) which is connected to one of the two sensors (11, 13) to display the received signal values (E_{E} or E_{Z} respectively) of this sensor.

18. A digital camera in accordance with claim 17, characterized in that the camera has a switching device (37) by means of which selectively either the first sensor (11) or the second sensor (13) can be connected to the electronic viewfinder (35).

19. A digital camera in accordance with claim 18, characterized in that the connection of the electronic viewfinder (35) to the first sensor (11) or to the second sensor (13) can be selected independently of whether the output value (A) is generated with reference to a received signal value (E_{E}) of a sensor element (21a, 21d) of the first sensor (11) or with reference to a received signal value (E_{Z}) of a sensor element (23) of the second sensor (13).

20. A method for the taking of images by means of a digital camera, in particular of a digital motion picture camera, having a first sensor (11) and a second sensor (13), said sensors (11, 13) each including a plurality of sensor elements (21, 23), wherein
a beam splitter (15) directs received light onto the first sensor (11) and onto the second sensor (13), with the sensor elements (21) of the first sensor (11) being associated with the sensor elements (23) of the second sensor (13) such that the mutually associated sensor elements (21, 23) detect the same image regions;
the sensor elements (21, 23) generate exposure-dependent received signals (E_{E}, E_{Z}), with the sensors (11, 13) and the beam splitter (15) being configured such that, when the same image is taken, the mutually associated sensor elements (21, 23) generate different received signal values (E_{E}, E_{Z});
the received signal values (E_{E}, E_{Z}) of at least some (21a, 21) of the sensor elements (21) of the first sensor (11) or of the second sensor (13) are compared with a respective threshold value (S_{E}, S_{Z}); and
either the received signal value (E_{E}) of the sensor element (21a, 21d) of the first sensor (11) or the received signal value (E_{Z}) of the associated sensor element (23) or of a plurality of associated sensor elements (23) of the second sensor (13) is selected for the generation of a respective output value (A) in dependence on the result of the respective comparison.

21. A method in accordance with claim 20, characterized in that a sensor is used as the second sensor (13) whose sensor elements (23) have a sensitivity which is less than the sensitivity of the sensor elements (21) of the first sensor (11).

22. A method in accordance with claim 20, characterized in that a sensor is used as the second sensor (13) which has a higher resolution than the first sensor (11).

23. A method in accordance with claim 20, characterized in that the beam splitter (15) directs a lower quantity of light in the direction of the second sensor (13) than in the direction of the first sensor (11).

24. A method in accordance with claim 20, characterized in that a color sensor is used as the first sensor (11) whose sensor elements (21) are divided into a plurality of groups, with the sensor elements (21) of the different groups having different spectral sensitivities.

25. A method in accordance with claim 20, characterized in that a monochrome sensor is used as the second sensor (13) whose sensor elements (23) all have the same spectral sensitivity.

26. A method in accordance with claim 20, characterized in that the respective output value (A) is generated on the basis of the received signal value (E_{E}) of the sensor element (21a, 21d) of the first sensor (11) with a received signal value (E_{E}, E_{Z}) of a sensor element (21a, 21d) of the first sensor (11) or of the second sensor (13) which is smaller than the threshold value (S_{E}, S_{Z}).

27. A method in accordance with claim 20, characterized in that the respective output value (A) is generated on the basis of the received signal value (E_{Z}) of the sensor element (23) or of the plurality of sensor elements (23) of the second sensor (13) with a received signal value (E_{E}, E_{Z}) of a sensor element (21a, 21d) of the first sensor 11 or of the second sensor (13) which exceeds the threshold value (S_{E}, S_{Z}).

28. A method in accordance with claim 20, characterized in that a color sensor is used as the first sensor (11) whose sensor elements (21) are divided into a plurality of groups, with the sensor elements (21) of the different groups having different spectral sensitivities;
in that a monochrome sensor is used as the second sensor (13) whose sensor elements (23) all have the same spectral sensitivity, with the second sensor (13) having a higher spatial resolution than the first sensor (11);
in that edge structures are identified in the respective image on the basis of the received signal values (E_{Z}) of the second sensor (13) having a higher resolution; and
in that, for a color interpolation of the received signal values (E_{E}) of the first sensor (11) having a lower resolution, the respective interpolation environment is selected in dependence on the identified edge structures.
